(19) United States
(12) Patent Application Publication
(10) Pub. No.: US 2013/0050427 A1
(43) Pub. Date: Feb. 28, 2013

(54) METHOD AND APPARATUS FOR CAPTURING THREE-DIMENSIONAL IMAGE AND APPARATUS FOR DISPLAYING THREE-DIMENSIONAL IMAGE

(71) Applicants: Hong-Long Chou, Taipei City (TW); Chia-Chun Tseng, Hsinchu City (TW)

(72) Inventors: Hong-Long Chou, Taipei City (TW); Chia-Chun Tseng, Hsinchu City (TW)

(73) Assignee: ALTEK CORPORATION, Hsinchu City (TW)

(21) Appl. No.: 13/244,668

(22) Filed: Sep. 25, 2011

(30) Foreign Application Priority Data
Aug. 31, 2011 (TW) 100131327

(51) Int. Cl. H04N 13/02

(52) U.S. Cl. 348/46; 348/E13.074

(57) ABSTRACT

A method and an apparatus for capturing a three-dimensional image and an apparatus for displaying the three-dimensional image are provided. The method is adapted to an image capturing apparatus including the following steps. First, a plurality of images are captured with continuous pan. Next, a disparity between each two adjacent images is estimated from the images. Then, the images and the disparities are stored.

### CROSS-REFERENCE TO RELATED APPLICATION

This application claims the priority benefit of Taiwan application serial no. 100131327, filed on Aug. 31, 2011. The entirety of the above-mentioned patent application is hereby incorporated by reference herein and made a part of this specification.

### BACKGROUND OF THE INVENTION

1. Field of the Invention

The invention relates to a method and an apparatus for capturing a three-dimensional image and an apparatus for displaying the three-dimensional image. Particularly, the invention relates to a method and an apparatus for capturing a three-dimensional image that are capable of adjusting a disparity, and an apparatus for displaying the three-dimensional image.

2. Description of Related Art

With development of technology, three-dimensional (3D) images are latest development trend after high definition (HD) images. Various 3D image-related industries quickly rise, and besides 3D image display apparatus (for example, televisions) and 3D image receiving apparatus (for example, 3D glasses), 3D image capturing apparatus suitable for consumers are also developed.

When two eyes observe an object in a tiny viewing angle difference, the two eyes may view two images with a tiny difference, and such tiny difference observed by the two eyes is referred to as binocular disparity or retinal disparity. The brain merges the two images with the tiny difference into a single object with levels and a depth of field, so as to form a 3D perception effect in the brain. However, a horizontal distance between the two eyes (which is also referred to as an interpupillary distance (IPD)) is about 50-75 mm, which is varied from individual to individual, and feelings of different people for a 3D image are also different.

Therefore, the 3D image capturing apparatus has to capture images for providing to the left eye and the right eye. A commonly used method is to use different capturing apparatus to capture a plurality of images from different angles, and then perform post-synthesis, or two independent lenses are equipped on a body of the capturing apparatus, and a distance between the two lenses is set to an average distance of human two eyes, so as to simulate the left eye and the right eye to capture 3D images. However, hardware cost of the aforementioned apparatus is expensive and the apparatus is not easy in operation for consumers.

### SUMMARY OF THE INVENTION

Accordingly, the invention is directed to a method and an apparatus for capturing a three-dimensional image, in which an image capturing apparatus having a single lens is used to capture images, and left-eye images and right-eye images with different disparities are output according to a user setting.

The invention is directed to an apparatus for displaying a three-dimensional image, which receives a plurality of images with disparity information, and selects left-eye and right-eye images with different disparities to present three-dimensional images according to user settings.

The invention provides a method for capturing a three-dimensional image, which is adapted to an image capturing apparatus, and the method includes the following steps. First, a plurality of images are captured with continuous pan. Next, a disparity between each two adjacent images is estimated from the images. Then, the images and the disparities are stored.

In an embodiment of the invention, the method for capturing the three-dimensional image further includes following steps. First, a first disparity is obtained. Then, a first left-eye image and a first right-eye image are obtained from the images according to the first disparity and the disparities, where the first left-eye image and the first right-eye image have a difference of the first disparity. Then, a first three-dimensional image is presented according to the first left-eye image and the first right-eye image.

In an embodiment of the invention, after the step of presenting the first three-dimensional image, the method further includes following steps. A second disparity is received through a user interface. Then, a second left-eye image and a second right-eye image are obtained from the images according to the second disparity and the disparities, where the second left-eye image and the second right-eye image have a difference of the second disparity. Then, a second three-dimensional image is presented according to the second left-eye image and the second right-eye image.

In an embodiment of the invention, the step of estimating the disparity between each two adjacent images from the images includes following steps. First, the images are respectively divided into a plurality of blocks. Then, a local motion vector of each of the blocks between each two adjacent images is calculated. Then, the local motion vectors are analysed to produce a global motion vector between each two adjacent images. Then, the disparity is estimated according to the global motion vectors.

In an embodiment of the invention, the method further includes a following step. The images are corrected according to the global motion vectors to coincide vertical heights of the corrected images.

In an embodiment of the invention, the step of using the image capturing apparatus to capture the images with continuous pan includes following steps. First, the image capturing apparatus is triggered to capture the images. Then, a displacement information of the image capturing apparatus is detected. Then, it is determined whether the image capturing apparatus is panned along a horizontal direction according to the displacement information. When the image capturing apparatus is not panned along the horizontal direction, a user is notified to correct movement of the image capturing apparatus.

In an embodiment of the invention, the method for capturing the three-dimensional image further includes a following step. The images are warped according to the displacement information to parallel viewing angle directions of the corrected images.

In an embodiment of the invention, the step of using the image capturing apparatus to capture the images with continuous pan includes following steps. First, the image capturing apparatus is triggered to capture the images. Then, when a sum of the disparities reaches a threshold, the image capturing apparatus stops capturing the images.

The invention provides an apparatus for capturing a three-dimensional image, which includes an image capturing module, a processing unit and a storage unit. The image capturing module is used to capture a plurality of images with continuous pan. The processing unit is coupled to the image capturing module, and when the image capturing module is used to capture the images with continuous pan along the direction, the processing unit estimates a disparity between each two adjacent images from the images. The storage unit is coupled to the image capturing module and the processing unit and is used for storing the images and the disparities.

The invention provides an apparatus for displaying a three-dimensional image, adapted to receive a plurality of images captured with continuous pan and a disparity between each two adjacent images of the images, and the apparatus for displaying the three-dimensional image includes a storage unit, a processing unit and a display module. The storage unit stores a first disparity. The processing unit is coupled to the storage unit, and obtains a left-eye image and a right-eye image from the images according to the first disparity and the disparities. The display module is coupled to the processing unit, and displays a three-dimensional image according to the left-eye image and the right-eye image.

According to the above descriptions, in the method and apparatus for capturing a three-dimensional image and the apparatus for displaying the three-dimensional image, a three-dimensional image capturing apparatus with a single lens is used for capturing images. By storing disparity information of the images, the left-eye and right-eye images with different disparities can be output, so that the user can select the most suitable left-eye and right-eye images to present the three-dimensional images according to his perception and preference.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a three-dimensional (3D) image capturing apparatus according to an embodiment of the invention.

FIG. 2 is a flowchart illustrating a method for capturing a 3D image according to an embodiment of the invention.

FIG. 3 is a schematic diagram of a pan track and captured images according to an embodiment of the invention.

FIG. 4 is a flowchart of a method for capturing a 3D image according to another embodiment of the invention.

FIG. 5 is a block diagram of a 3D image capturing apparatus according to another embodiment of the invention.

FIG. 6 is a flowchart of a method for capturing a 3D image according to still another embodiment of the invention.

FIG. 7 is a schematic diagram of image warping according to an embodiment of the invention, in which (a) shows images before image warping, and (b) shows the warped images.

FIG. 8 is a schematic diagram illustrating warped images I′1-I′5 and corresponding disparity GMV according to an embodiment of the invention.

FIG. 9 is a schematic diagram of disparity adjustment according to another embodiment of the invention, in which (a) represents disparity increase, and (b) represents disparity decrease.

FIG. 10 is a block diagram illustrating a 3D image display apparatus connected to the 3D image capturing apparatus of FIG. 1.

### DETAILED DESCRIPTION OF DISCLOSED EMBODIMENTS

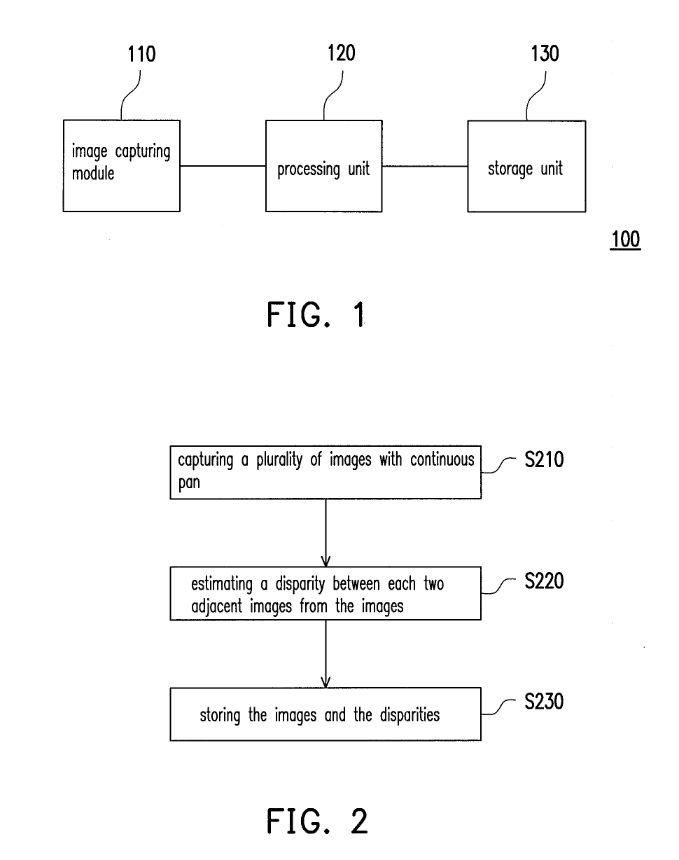

FIG. 1 is a block diagram of a three-dimensional (3D) image capturing apparatus according to an embodiment of the invention. Referring to FIG. 1, the 3D image capturing apparatus 100 is, for example, a digital camera, a mobile phone or a smart phone, etc. having an image capturing function. The 3D image capturing apparatus 100 includes an image capturing module 110, a processing unit 120 and a storage unit 130. The processing unit 120 is coupled to the image capturing module 110 and the storage unit 130. The processing unit 120 is used for calculating disparities of the images captured by the image capturing module 110, and performing image processing. The processed images and the disparities can be stored in the storage unit 130. Functions of the devices are described as follows.

The image capturing module 110 includes a lens or a photo sensing device. The lens is, for example, a standard lens, a wide-angle lens, a telephoto lens and a zoom lens, etc. The photo sensing device is, for example, a charge coupled device (CCD), a complementary metal-oxide semiconductor (CMOS) device or other devices, etc.

The processing unit 120 can be implemented by software, hardware or a combination thereof, which is not limited by the invention. The software is, for example, application software or a driving program, etc. The hardware is, for example, a central processing unit (CPU), or a programmable general purpose or special purpose microprocessor, or a digital signal processor (DSP), etc.

The storage unit 130 can be a fixed or movable random access memory (RAM), a read-only memory (ROM), a flash memory, a memory card or other similar devices.

FIG. 2 is a flowchart illustrating a method for capturing a 3D image according to an embodiment of the invention. Referring to FIG. 2, the method of the embodiment is adapted to the 3D image capturing apparatus 100 of FIG. 1, and steps of the method for capturing the 3D image are introduced below with reference of various devices shown in FIG. 1.

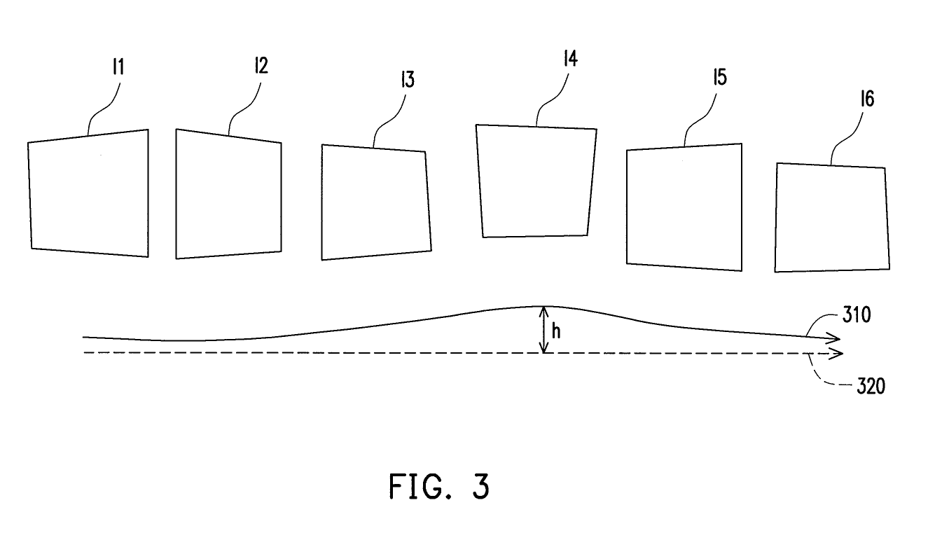

First, in step S210, the 3D image capturing apparatus 100 is used to capture a plurality of images with continuous pan, where a direction of the continuous pan can be a horizontal direction, for example, from the left to the right or from the right to the left. As shown in FIG. 3, FIG. 3 is a schematic diagram of a pan track and captured images according to an embodiment of the invention. Then, in step S220, when the image capturing module 110 continuously captures a plurality of images I1-I6 along a pan track 310, the processing unit 120 estimates a disparity between each two adjacent images from the images I1-I6. Then, in step S230, the storage unit 130 stores the images I1-I6 and the disparity between each two adjacent images.

It should be noticed that the 3D image capturing apparatus 100 estimates the disparities between the images, and stores the images and the disparities in the storage unit 130. Therefore, when a 3D image is to be produced, two images stored in the storage unit 130 can be selected according to the disparity to serve as a left-eye image and a right-eye image. Then, the selected left-eye image and right-eye image are used to produce the 3D image. Namely, in the present embodiment, the single 3D image capturing apparatus 100 and the single lens are used to capture images used for presenting the 3D images other than using two or more image capturing apparatus or a single image capturing apparatus equipped with two lenses to respectively capture left-eye and right-eye images in order to present the 3D images as that does of the conventional technique.

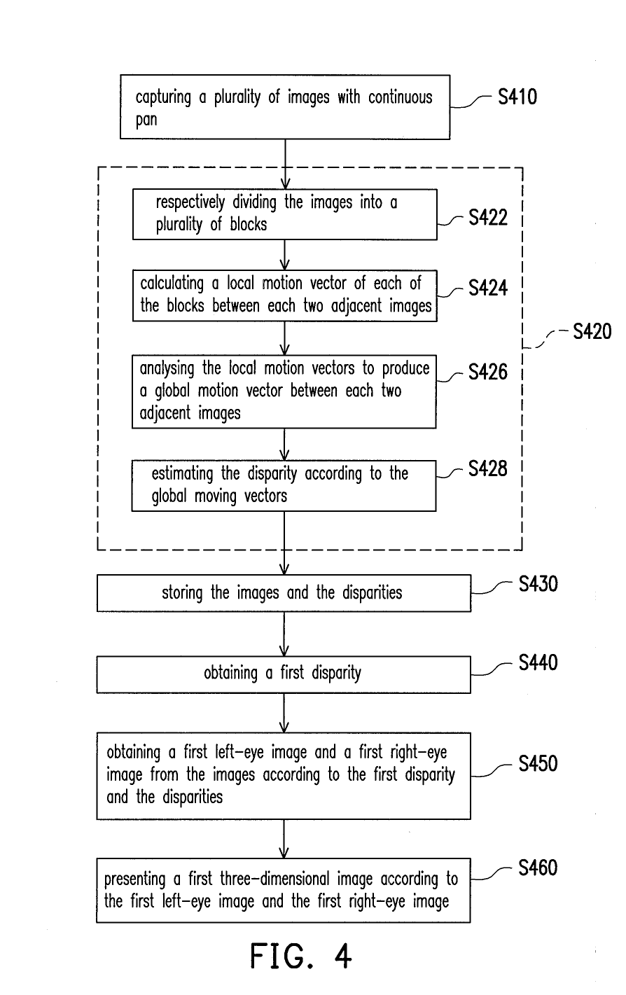

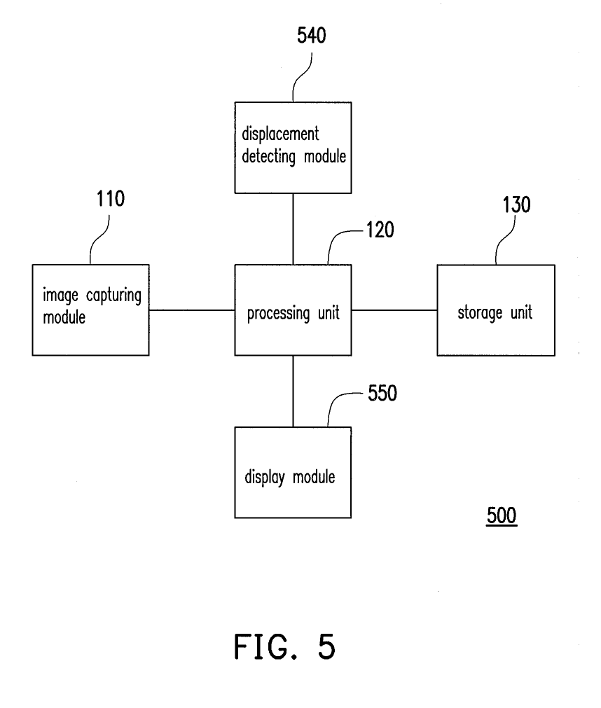

Another embodiment is provided below for description. FIG. 4 is a flowchart of a method for capturing a 3D image according to another embodiment of the invention. FIG. 5 is a block diagram of a 3D image capturing apparatus according to another embodiment of the invention. In the present embodiment, besides the image capturing module 110, the processing unit 120 and the storage unit 130, the 3D image capturing apparatus 500 further includes a displacement detecting module 540 and a display module 550. The displacement detecting module 540 and the display module 550 are respectively coupled to the processing unit 120. The displacement detecting module 540 can store the displacement information to the storage unit 130 through the processing unit 120. The display module 550 can access the images stored in the storage unit 130 through the processing unit 120 for playing.

The display module 550 is, for example, a liquid crystal display (LCD) display panel, a light-emitting diode (LED) display panel, or a display module having a touch receiving function, which is used for displaying the images captured by the 3D image capturing apparatus 500.

The displacement detecting module 540 is, for example, a G-sensor or a gyroscope, which can detect displacement information of the 3D image capturing apparatus 500, and provides the displacement information to the processing unit 120.

Referring to FIG. 3, FIG. 4 and FIG. 5, first, in step S410, the 3D image capturing apparatus 500 is used to capture a plurality of the images I1-I6 (shown in FIG. 3) with continuous pan. Then, in step S420, the processing unit 120 estimates an image disparity between each two adjacent images from the images I1-I6.

In detail, the step S420 includes four steps S422-S428. First, in the step S422, the processing unit 120 groups the images I1-I6 into a plurality of blocks. For example, each of the images is divided into M×N blocks, where M and N are positive integer greater than 1. Then, in the step S424, the processing unit 120 performs local motion estimation. For example, a feature detection method is used to estimate a possible motion position of each block between two adjacent images.

After the local motion estimation of each of the blocks is performed, in the step S426, the processing unit 120 performs a global motion estimation to produce a global motion vector between each two adjacent images. For example, a mode of the local motion vectors is first obtained, and after the statistics, the local motion vector with the highest frequently is selected as the global motion vector, or all of the local motion vectors are averaged to obtain the global motion vector, etc.

Then, in the step S428, the processing unit 120 performs a smoothing processing on the global motion vector, and takes the smoothed global motion vector as the image disparity. In this way, influence of error generated by the motion vector estimation is reduced.

Then, in step S430, the storage unit 130 stores the images I1-I6 and the image disparity between each of two adjacent images. In the present embodiment, the images can be compressed according to H.264 standard, a motion picture experts group (MPEG) standard or a joint photographic experts group (JPEG) standard, etc., and the image disparities can be stored in the corresponding format.

Then, in steps S440-460, the processing unit 120 obtains a first disparity from the storage unit 130, where the first disparity can be a predetermined value of the 3D image capturing apparatus 500 or can be predetermined by the user. The processing unit 120 obtains a first left-eye image and a first right-eye image having a difference of the first disparity from the images stored in the storage unit 130 according to the first disparity and the disparities. Finally, a first 3D image is presented according to the first left-eye image and the first right-eye image.

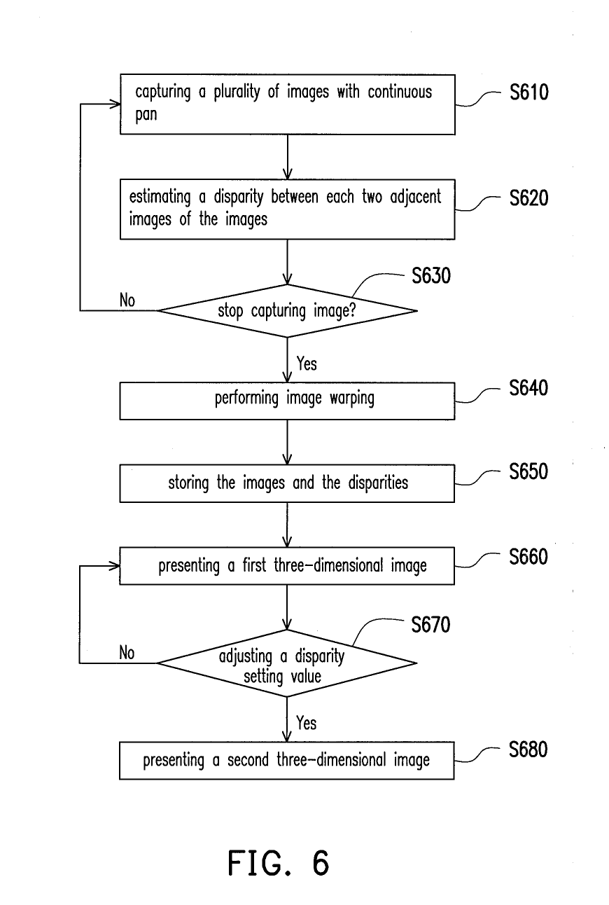

FIG. 6 is a flowchart of a method for capturing a 3D image according to still another embodiment of the invention. The method of the embodiment is adapted to the 3D image capturing apparatus 500 of FIG. 5, and is described below with reference of FIG. 3, FIG. 5 and FIG. 6.

First, in step S610, the 3D image capturing apparatus 500 is used to capture a plurality of images with continuous pan. In the present embodiment, the 3D image capturing apparatus 500 is, for example, a digital camera. The user generally holds the digital cameral for photographing, so that the 3D image capturing apparatus 500 first receives a trigger signal to start the image capturing operation, for example, receives a button trigger operation from the user. Since the user holds the digital camera to capture images with continuous pan, the captured images may have problems of skew, and unparallel viewing angles, etc. (shown in FIG. 3) due to hand tremor or shaking. Therefore, the displacement detecting module 540 is used to detect and obtain the displacement information of the 3D image capturing apparatus 500, and it is determined whether the 3D image capturing apparatus 500 is panned along a horizontal direction according to the displacement information. If it is detected that the 3D image capturing apparatus 500 is not panned along the horizontal direction, the display module 550 is used to display a prompt frame to notify the user to correct the motion direction. For example, an arrow pointed upwards or downwards can be displayed in the prompt frame to notify the user the direction to be corrected.

Then, in step S620, the processing unit 120 estimates the local motion vector and the global motion vector between each two adjacent images, and obtains the disparity through the global motion vector estimation. It should be noticed that the processing unit 120 can correct a height difference h (shown in FIG. 3) of the images along the vertical direction according to the global motion vectors, so that the corrected images are all located at a same vertical height. In this way, the corrected images are close to a capturing result of continuous pan. Namely, a continuous pan direction of the 3D image capturing apparatus 500 is a pan track 320.

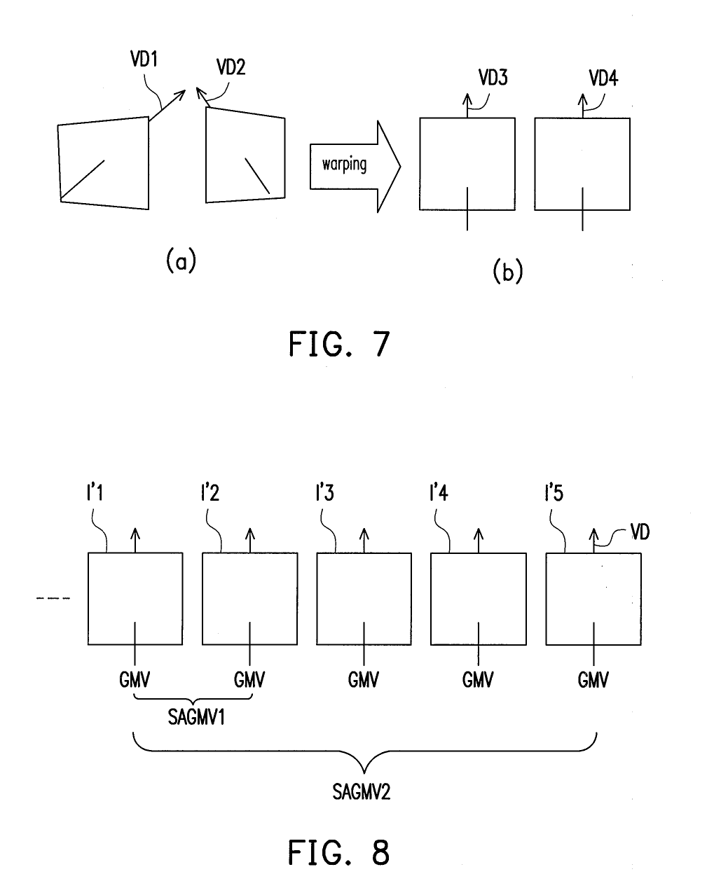

After the disparity is obtained, the processing unit 120 determines whether the disparity exceeds a first disparity (step S630), and if yes, the 3D image capturing apparatus 500 automatically stops capturing images. Then, the 3D image capturing apparatus 500 corrects the captured images (step S640). The processing unit 120 can warp the images according to the displacement information obtained by the displacement detecting module 540, so that viewing angle directions of the images are parallel to each other after the correction. In another embodiment that is not illustrated, a transformation matrix (for example, a 3×3 transformation matrix) is used to transform the images, so that the viewing angle directions of the images are parallel to each other after the transformation. FIG. 7 is a schematic diagram of image warping according to an embodiment of the invention, in which (a) shows images before image warping, and (b) shows the warped images. As shown in FIG. 7, before the image warping, viewing angle directions VD1 and VD2 of the images are not parallel, and after the image warping, the viewing angle directions VD3 and VD4 are parallel.

Then, the storage unit 130 can store all of the warped images and the corresponding disparities (step S650). FIG. 8 is a schematic diagram illustrating warped images I′1-I′5 and the corresponding disparity GMV according to an embodiment of the invention. Referring to FIG. 8, the warped image I′1-I′5 are all located on a same vertical height and the viewing angle directions thereof are parallel to each other.

Then, the display module 550 presents a first 3D image according to the first left-eye image and the first right-eye image (step S660). Since a perception effect of the 3D image is varied from individual to individual, if the first disparity is the predetermined value of the 3D image capturing apparatus 500, the invention further provides a disparity set by the user, and the 3D image capturing apparatus 500 calculates to obtain the left-eye and right-eye images suitable for the user according to the disparity set by the user.

Therefore, after the first 3D image is presented, the 3D image capturing apparatus 500 further displays a user interface through the display module 550 to notify the user whether or not to adjust a disparity setting value (step S670). If yes, the 3D image capturing apparatus 500 receives a second disparity set by the user, and obtains a second left-eye image and a second right-eye image from the images stored in the storage unit 130 according to the second disparity and the disparities stored in the storage unit 130. Finally, the display module 550 presents a second 3D image according to the second left-eye image and the second right-eye image (step S680).

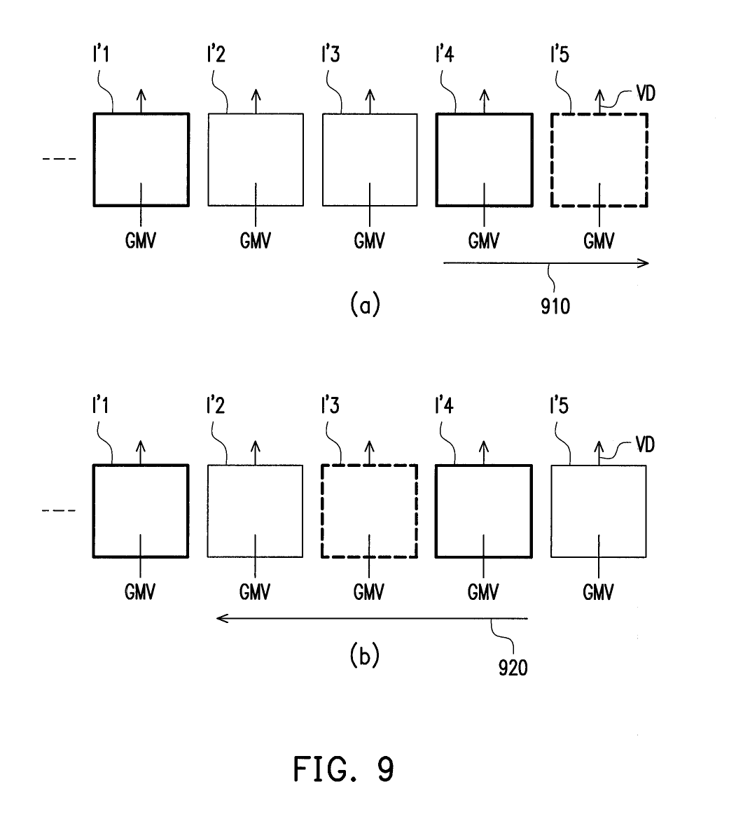

FIG. 9 is a schematic diagram of disparity adjustment according to another embodiment of the invention, in which (a) represents disparity increase, and (b) represents disparity decrease. Referring to FIG. 9, if the corrected image I′1 and the corrected image I′4 are respectively the first left-eye image and the first right-eye image, when the user wants to increase the disparity between the left-eye image and the right-eye image, besides directly inputting an exact second disparity, in the present embodiment, the user can also set a command for increasing the disparity between the left-eye image and the right-eye image, and the 3D image capturing apparatus selects an image (for example, an image I′5) along an arrow direction 910 to serve as another left-eye image or right-eye image. Comparatively, when the user wants to decrease the disparity between the left-eye image and the right-eye image, the 3D image capturing apparatus selects an image (for example, an image I′3) along an arrow direction 920 to serve as another left-eye image or right-eye image.

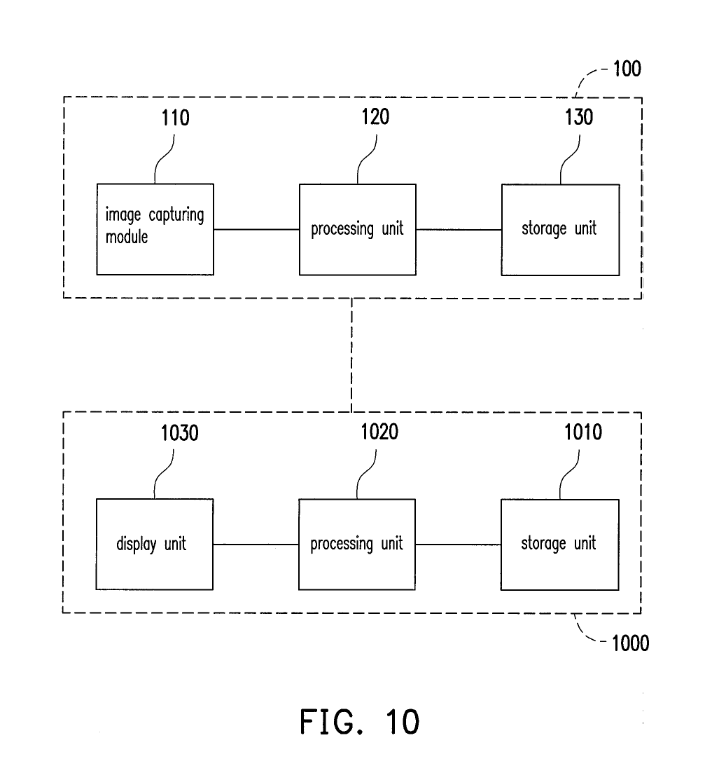

According to another aspect, the invention provides a 3D image display apparatus. FIG. 10 is a block diagram illustrating a 3D image display apparatus connected to the 3D image capturing apparatus of FIG. 1. Referring to FIG. 1 and FIG. 10, the 3D image capturing apparatus 100 of FIG. 1 is, for example, connected to the 3D image display apparatus 1000 through a connection unit (not shown). The connection unit can be an input output interface, for example, a universal serial bus (USB) interface connector, an antenna or a transceiver, etc. Therefore, the 3D image capturing apparatus 100 can transmit images and disparities to the 3D image display apparatus 1000 through the connection unit via a cable channel or a wireless channel.

The 3D image display apparatus 1000 is, for example, a television, or a computer, etc., which includes a storage unit 1010, a processing unit 1020 and a display module 1030. The storage unit 1010 stores the first disparity. The processing unit 1020 is coupled to the storage unit 1010 and obtains the left-eye image and the right-eye image from the images according to the first disparity and the image disparities. The display module 1030 is coupled to the processing unit 1020, and presents a 3D image according to the left-eye image and the right-eye image. The other details of the present embodiment have been described in detail in the aforementioned embodiments, which are not repeated herein.

In summary, in the method and apparatus for capturing a three-dimensional image and the apparatus for displaying the three-dimensional image, the three-dimensional image capturing apparatus with a single lens is used to capture images with continuous pan. By storing disparity information of the images, the left-eye and right-eye images with different disparities can be output, so that the user can select the most suitable left-eye and right-eye images to present the 3D images according to his perception and preference. In this way, beside easy in operation, it is unnecessary to purchase expensive capturing devices to capture images from different angles, by which the production cost is saved.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for capturing a three-dimensional image, adapted to an image capturing apparatus, comprising:
capturing a plurality of images with continuous pan;
estimating a disparity between each two adjacent images from the images; and
storing the images and the disparities.

2. The method for capturing the three-dimensional image as claimed in claim 1, further comprising:
obtaining a first disparity;
obtaining a first left-eye image and a first right-eye image from the images according to the first disparity and the disparities, wherein the first left-eye image and the first right-eye image have a difference of the first disparity; and
presenting a first three-dimensional image according to the first left-eye image and the first right-eye image.

3. The method for capturing the three-dimensional image as claimed in claim 2, wherein after the step of presenting the first three-dimensional image, the method further comprises:
receiving a second disparity through a user interface;
obtaining a second left-eye image and a second right-eye image from the images according to the second disparity and the disparities, wherein the second left-eye image and the second right-eye image have a difference of the second disparity; and
presenting a second three-dimensional image according to the second left-eye image and the second right-eye image.

4. The method for capturing the three-dimensional image as claimed in claim 1, wherein the step of estimating the disparity between each two adjacent images from the images comprises:
respectively dividing the images into a plurality of blocks;
calculating a local motion vector of each of the blocks between each two adjacent images;
analysing the local motion vectors to produce a global motion vector between each two adjacent images; and
estimating the disparity according to the global motion vectors.

5. The method for capturing the three-dimensional image as claimed in claim 4, further comprising:
correcting the images according to the global motion vectors to coincide vertical heights of the corrected images.

6. The method for capturing the three-dimensional image as claimed in claim 1, wherein the step of using the image capturing apparatus to capture the images with continuous pan comprises:
triggering the image capturing apparatus to capture the images;
detecting displacement information of the image capturing apparatus;
determining whether the image capturing apparatus is panned along a horizontal direction according to the displacement information; and
notifying a user to correct movement of the image capturing apparatus when the image capturing apparatus is not panned along the horizontal direction.

7. The method for capturing the three-dimensional image as claimed in claim 6, further comprising:
warping the images according to the displacement information to parallel viewing angle directions of the corrected images.

8. The method for capturing the three-dimensional image as claimed in claim 1, wherein the step of using the image capturing apparatus to capture the images with continuous pan comprises:
triggering the image capturing apparatus to capture the images; and
making the image capturing apparatus to stop capturing the images when a sum of the disparities reaches a threshold.

9. An apparatus for capturing a three-dimensional image, comprising:
an image capturing module, capturing a plurality of images with continuous pan;
a processing unit, coupled to the image capturing module, wherein when the image capturing module is continuously panned to capture the images, the processing unit estimates a disparity between each two adjacent images from the images; and
a storage unit, coupled to the image capturing module and the processing unit, and storing the images and the disparities.

10. The apparatus for capturing the three-dimensional image as claimed in claim 9, wherein
the storage unit stores a first disparity, and the processing unit obtains a first left-eye image and a first right-eye image from the images according to the first disparity and the disparities, wherein the first left-eye image and the first right-eye image have a difference of the first disparity.

11. The apparatus for capturing the three-dimensional image as claimed in claim 10, further comprising:
a display module, coupled to the processing unit, and presenting a first three-dimensional image according to the first left-eye image and the first right-eye image.

12. The apparatus for capturing the three-dimensional image as claimed in claim 11, wherein
the display module displays a user interface to receive a second disparity through the user interface, the processing unit obtains a second left-eye image and a second right-eye image from the images according to the second disparity and the disparities, and the display module presents a second three-dimensional image according to the second left-eye image and the second right-eye image.

13. The apparatus for capturing the three-dimensional image as claimed in claim 11, further comprising:
a displacement detecting module, coupled to the image capturing module and the processing unit, and obtaining a displacement information of the image capturing apparatus, wherein the processing unit determines whether the image capturing apparatus is panned along a horizontal direction according to the displacement information, and when the image capturing apparatus is not panned along the horizontal direction, the display module displays a prompt frame to notify a user to correct movement of the image capturing apparatus.

14. The apparatus for capturing the three-dimensional image as claimed in claim 9, wherein when the processing unit calculates a sum of the disparities to reach a threshold, the image capturing apparatus stops capturing the images.

15. An apparatus for displaying a three-dimensional image, adapted to receive a plurality of images captured with continuous pan and a disparity between each two adjacent images of the images, and the apparatus for displaying the three-dimensional image comprising:
a storage unit, storing a first disparity;
a processing unit, coupled to the storage unit, and obtaining a left-eye image and a right-eye image from the images according to the first disparity and the disparities; and
a display module, coupled to the processing unit, and displaying a three-dimensional image according to the left-eye image and the right-eye image.

16. The apparatus for displaying the three-dimensional image as claimed in claim 15, wherein
the display module displays a user interface to receive a second disparity through the user interface, the processing unit obtains a second left-eye image and a second right-eye image from the images according to the second disparity and the disparities, and the display module presents a second three-dimensional image according to the second left-eye image and the second right-eye image.
